(19) United States
(12) Patent Application Publication
(10) Pub. No.: US 2018/0279121 A1
(43) Pub. Date: Sep. 27, 2018

(54) CONNECTION PROPRIETY DETERMINATION DEVICE AND METHOD, PROGRAM, AND RECORDING MEDIUM

(71) Applicant: ALLIED TELESIS HOLDINGS K.K., Tokyo (JP)

(72) Inventor: Atsushi Nagashima, Japan (JP)

(21) Appl. No.: 15/546,796

(22) PCT Filed: Aug. 19, 2016
(86) PCT No.: PCT/JP2016/074201

§ 371 Date: Jul. 27, 2017

(51) Int. Cl. H04W 12/06; H04L 29/06; H04L 29/12

(52) U.S. Cl. CPC H04W 12/06; H04W 84/12; H04L 61/6022; H04L 63/0876

(57) ABSTRACT

According to the present invention, a connection propriety determination system determines propriety of a request from a wireless LAN client that requests connection with a network. A connection propriety determination unit determines the propriety of connection of the wireless LAN client to the network based on a received MAC address and a connection propriety list determined to be used. When the connection has been determined to be allowable, an SSID determination unit determines a SSID for use in connection with the network, based on a connection propriety list used to determine the allowance of the connection and contents stored in a SSID storage unit.

### TECHNICAL FIELD

The present invention relates to MAC (Media Access Control) address authentication.

### BACKGROUND ART

A MAC address authentication function is conventionally known. The MAC address authentication function is designed to determine the propriety of connection of a client by comparing a MAC address of the client requesting the connection to a network with a MAC address authentication database that records therein the propriety of connection for each MAC address.

### SUMMARY OF INVENTION

However, the MAC address authentication database does not store information on a Service Set Identifier (SSID), and thus cannot execute authentication associated with the SSID.

Accordingly, it is an object of the present invention to execute authentication associated with an SSID by a MAC address authentication function.

According to the present invention, a connection propriety determination system determines propriety of a request from a wireless LAN client that requests connection with a network, the connection propriety determination system including: a connection propriety storage unit that stores a plurality of connection propriety lists, each of the connection propriety lists being adapted to store the propriety of connection of the wireless LAN client to the network for a MAC address of the wireless LAN client; a use-list storage unit that stores which one of the connection propriety lists is to be used for the MAC address of the wireless LAN client; an SSID storage unit that stores SSIDs to which the connection propriety lists correspond, respectively; a use-list determination unit that receives the MAC address from the wireless LAN client and determines which one of the connection propriety lists is to be used, based on contents stored in the use-list storage unit; a connection propriety determination unit that based on the received MAC address and the connection propriety list determined to be used, determines the propriety of connection of the wireless LAN client to the network; and an SSID determination unit that, when the connection has been determined to be allowable, determines the corresponding SSID for use in connection with the network, based on the connection propriety list used to determine the allowance of the connection and contents stored in the SSID storage unit.

According to the thus constructed connection propriety determination system, propriety of a request from a wireless LAN client that requests connection with a network is determined. A connection propriety storage unit stores a plurality of connection propriety lists, each of the connection propriety lists being adapted to store the propriety of connection of the wireless LAN client to the network for a MAC address of the wireless LAN client. A use-list storage unit stores which one of the connection propriety lists is to be used for the MAC address of the wireless LAN client. An SSID storage unit stores SSIDs to which the connection propriety lists correspond, respectively. A use-list determination unit receives the MAC address from the wireless LAN client and determines which one of the connection propriety lists is to be used, based on contents stored in the use-list storage unit. A connection propriety determination unit determines the propriety of connection of the wireless LAN client to the network, based on the received MAC address and the connection propriety list determined to be used. When the connection has been determined to be allowable, an SSID determination unit determines the corresponding SSID for use in connection with the network, based on the connection propriety list used to determine the allowance of the connection and contents stored in the SSID storage unit.

According to the connection propriety determination system of the present invention, the use-list determination unit may reject a connection request from a wireless LAN client that has a MAC address not stored in the use-list storage unit.

According to the connection propriety determination system of the present invention, the connection propriety determination unit may reject a connection request from the wireless LAN client having the MAC address whose connection is rejected in any one of the connection priority lists determined to be used.

According to the present invention, a connection propriety determination system determines propriety of a request from a wireless LAN client that requests connection with a network, the connection propriety determination system including: a connection propriety storage unit that stores a plurality of connection propriety lists, each of the connection propriety lists being adapted to store the propriety of connection of the wireless LAN client to the network for a MAC address of the wireless LAN client; a use-list storage unit that stores which one of the connection propriety lists is to be used for each SSID; a use-list determination unit that determines which one of the connection propriety lists is to be used, based on the SSIDs received from the wireless LAN client; and a connection propriety determination unit that based on the MAC address received from the wireless LAN client and the connection propriety list determined to be used, determines the propriety of connection of the wireless LAN client to the network.

According to the thus constructed connection propriety determination system, propriety of a request from a wireless LAN client that requests connection with a network is determined. A connection propriety storage unit stores a plurality of connection propriety lists, each of the connection propriety lists being adapted to store the propriety of connection of the wireless LAN client to the network for a MAC address of the wireless LAN client. A use-list storage unit stores which one of the connection propriety lists is to be used for each SSID. A use-list determination unit determines which one of the connection propriety lists is to be used, based on the SSIDs received from the wireless LAN client. A connection propriety determination unit determines the propriety of connection of the wireless LAN client to the network, based on the MAC address received from the wireless LAN client and the connection propriety list determined to be used.

According to the present invention, a connection propriety determination method determines propriety of a request from a wireless LAN client that requests connection with a network, the connection propriety determination method including: storing a plurality of connection propriety lists, each of the connection propriety lists being adapted to store the propriety of connection of the wireless LAN client to the network for a MAC address of the wireless LAN client; storing which one of the connection propriety lists is to be used for the MAC address of the wireless LAN client; storing SSIDs to which the connection propriety lists correspond, respectively; receiving the MAC address from the wireless LAN client and determining which one of the connection propriety lists is to be used, based on contents stored in the storing of which one of the connection propriety lists is to be used for the MAC address; determining the propriety of connection of the wireless LAN client to the network, based on the received MAC address and the connection propriety list determined to be used; and determining the corresponding SSID for use in connection with the network, when the connection has been determined to be allowable, based on the connection propriety list used to determine the allowance of the connection and contents stored in the storing of the SSIDs.

The present invention is a program of instructions for execution by a computer to perform a connection propriety determination process of determining propriety of a request from a wireless LAN client that requests connection with a network, the connection propriety determination process including: storing a plurality of connection propriety lists, each of the connection propriety lists being adapted to store the propriety of connection of the wireless LAN client to the network for a MAC address of the wireless LAN client; storing which one of the connection propriety lists is to be used for the MAC address of the wireless LAN client; storing SSIDs to which the connection propriety lists correspond, respectively; receiving the MAC address from the wireless LAN client and determining which one of the connection propriety lists is to be used, based on contents stored in the storing of which one of the connection propriety lists is to be used for the MAC address; determining the propriety of connection of the wireless LAN client to the network, based on the received MAC address and the connection propriety list determined to be used; and determining the corresponding SSID for use in connection with the network, when the connection has been determined to be allowable, based on the connection propriety list used to determine the allowance of the connection and contents stored in the storing of the SSIDs.

The present invention is a non-transitory computer-readable medium having a program of instructions for execution by a computer to perform a connection propriety determination process of determining propriety of a request from a wireless LAN client that requests connection with a network, the connection propriety determination process including: storing a plurality of connection propriety lists, each of the connection propriety lists being adapted to store the propriety of connection of the wireless LAN client to the network for a MAC address of the wireless LAN client; storing which one of the connection propriety lists is to be used for the MAC address of the wireless LAN client; storing SSIDs to which the connection propriety lists correspond, respectively; receiving the MAC address from the wireless LAN client and determining which one of the connection propriety lists is to be used, based on contents stored in the storing of which one of the connection propriety lists is to be used for the MAC address; determining the propriety of connection of the wireless LAN client to the network, based on the received MAC address and the connection propriety list determined to be used; and determining the corresponding SSID for use in connection with the network, when the connection has been determined to be allowable, based on the connection propriety list used to determine the allowance of the connection and contents stored in the storing of the SSIDs.

According to the present invention, a connection propriety determination method determines propriety of a request from a wireless LAN client that requests connection with a network, the connection propriety determination method including: storing a plurality of connection propriety lists, each of the connection propriety lists being adapted to store the propriety of connection of the wireless LAN client to the network for a MAC address of the wireless LAN client; storing which one of the connection propriety lists is to be used for each SSID; determining which one of the connection propriety lists is to be used, based on the SSIDs received from the wireless LAN client; and determining the propriety of connection of the wireless LAN client to the network, based on the MAC address received from the wireless LAN client and the connection propriety list determined to be used.

The present invention is a program of instructions for execution by a computer to perform a connection propriety determination process of determining propriety of a request from a wireless LAN client that requests connection with a network, the connection propriety determination process including: storing a plurality of connection propriety lists, each of the connection propriety lists being adapted to store the propriety of connection of the wireless LAN client to the network for a MAC address of the wireless LAN client; storing which one of the connection propriety lists is to be used for each SSID; determining which one of the connection propriety lists is to be used, based on the SSIDs received from the wireless LAN client; and determining the propriety of connection of the wireless LAN client to the network, based on the MAC address received from the wireless LAN client and the connection propriety list determined to be used.

The present invention is a non-transitory computer-readable medium having a program of instructions for execution by a computer to perform a connection propriety determination process of determining propriety of a request from a wireless LAN client that requests connection with a network, the connection propriety determination process including: storing a plurality of connection propriety lists, each of the connection propriety lists being adapted to store the propriety of connection of the wireless LAN client to the network for a MAC address of the wireless LAN client; storing which one of the connection propriety lists is to be used for each SSID; determining which one of the connection propriety lists is to be used, based on the SSIDs received from the wireless LAN client; and determining the propriety of connection of the wireless LAN client to the network, based on the MAC address received from the wireless LAN client and the connection propriety list determined to be used.

### BRIEF DESCRIPTION OF DRAWINGS

FIG. 1 is a diagram showing a wireless LAN system according to a first embodiment of the invention;

FIG. 2 is a functional block diagram showing the configuration of the switch (connection propriety determination system) 14 in the first embodiment of the invention;

FIG. 3 is a diagram showing an example of the contents stored in the group-name storage unit (use-list storage unit) 140a;

FIG. 4 is a diagram showing an example of the connection propriety lists 140b-1, 140b-2, and 140b-3;

FIG. 5 is a diagram showing an example of the contents stored in the SSID storage unit 140c;

FIG. 6 is a diagram showing a wireless LAN system according to a second embodiment of the invention;

FIG. 7 is a configuration block diagram showing the configuration of the switch (connection propriety determination system) 14 in the second embodiment of the invention; and

FIG. 8 is a diagram showing an example of the contents stored in the group-name storage unit 140a according to the second embodiment.

### DESCRIPTION OF EMBODIMENTS

An embodiment of the present invention will be described below with reference to the drawings.

### First Embodiment

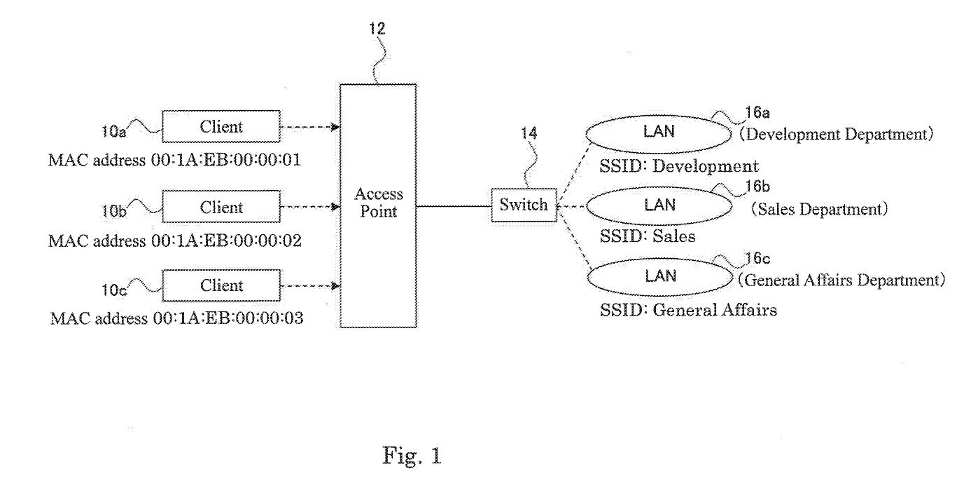

FIG. 1 is a diagram showing a wireless LAN system according to a first embodiment of the invention.

The wireless LAN system in the first embodiment of the invention includes wireless LAN clients 10a, 10b, and 10c, a wireless LAN access point 12, a switch (connection propriety determination system) 14, and LANs (networks) 16a, 16b, and 16c. Note that in some figures, the word “wireless LAN” is omitted and instead of this, the clients 10a, 10b, and 10c and the access point 12 are represented.

The wireless LAN clients 10a, 10b, and 10c request the switch (connection propriety determination system) 14 to make connections between LANs (networks) 16a, 16b, and 16c and the wireless LAN clients. More specifically, the wireless LAN clients 10a, 10b, and 10c conduct wireless communication with the wireless LAN access point 12, and send requests for connection with the LANs (networks) 16a, 16b, and 16c to the switch 14 via the wireless LAN access point 12.

A MAC address of the wireless LAN client 10a is 00:1A:EB:00:00:01, a MAC address of the wireless LAN client 10b is 00:1A:EB:00:00:02, and a MAC address of the wireless LAN client 10c is 00:1A:EB:00:00:03. Note that there can be other wireless LAN clients that request a connection, in addition to the wireless LAN clients 10a, 10b, and 10c, but for convenience of illustration, only the wireless LAN clients 10a, 10b, and 10c are illustrated.

The wireless LAN access point 12 conducts the wireless communication with the wireless LAN clients 10a, 10b, and 10c, while conducting wired communication with the switch 14. The wireless LAN access point 12 relays the communication between the wireless LAN clients 10a, 10b, and 10c and the switch 14.

The switch (connection propriety determination system) 14 determines the propriety of a request from the wireless LAN client 10a, 10b, or 10c that requests connection with the corresponding LAN (network) 16a, 16b, or 16c. The switch 14 relays the communication between the wireless LAN client 10a, 10b, or 10c and the LAN 16a, 16b, or 16c when it has accepted a request for connection from the wireless LAN client 10a, 10b, or 10c.

The LANs (networks) 16a, 16b, and 16c are supposed to be used in respective departments of a company by way of example. For example, LAN 16a is for a development department; LAN 16b for a sales department; and LAN 16c for a general affairs department. Note that the LANs 16a, 16b, and 16c are wireless LANs and may be virtual ones (e.g., VLAN). Each of the LANs 16a, 16b, and 16c has an SSID. Note that in the embodiments of the invention, the SSID includes an ESSID (Extended SSID) as a concept (note that the same goes for a second embodiment).

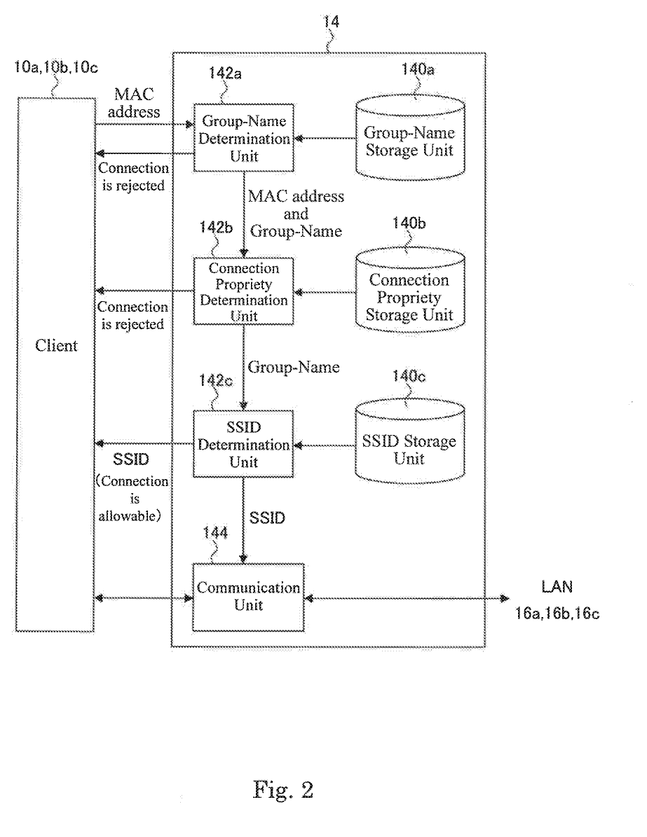

FIG. 2 is a functional block diagram showing the configuration of the switch (connection propriety determination system) 14 in the first embodiment of the invention. Note that although in reality, the wireless LAN access point 12 is interposed between the switch 14 and the wireless LAN clients 10a, 10b, and 10c (see FIG. 1), the illustration of the access point is omitted in FIG. 2.

The switch (connection propriety determination system) 14 in the first embodiment of the invention includes a group-name storage unit (use-list storage unit) 140a, a connection propriety storage unit 140b, an SSID storage unit 140c, a group-name determination unit (use-list determination unit) 142a, a connection propriety determination unit 142b, an SSID determination unit 142c, and a communication unit 144.

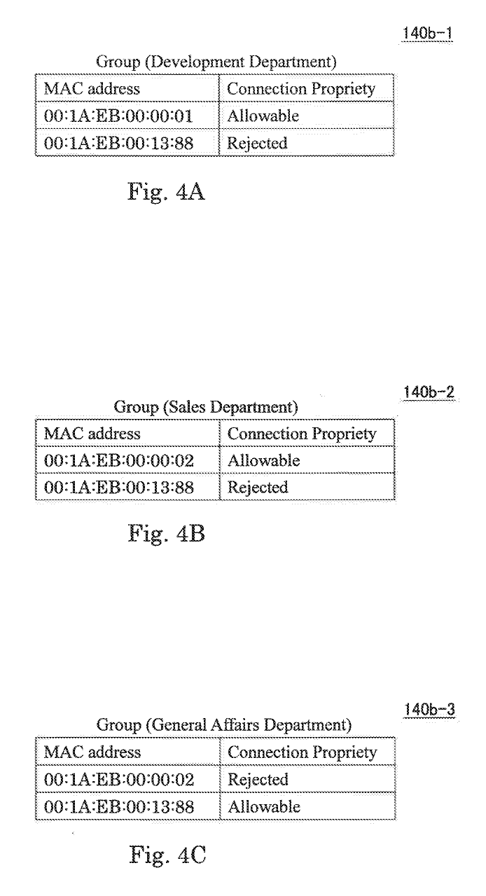

The connection propriety storage unit 140b stores the connection propriety lists 140b-1, 140b-2, and 140b-3 (see FIG. 4). There are three types of connection propriety lists 140b-1, 140b-2, and 140b-3, corresponding to the LANs 16a, 16b, and 16c in the first embodiment of the invention. Note that the number of connection propriety lists can be varied depending on the number of LANs. A plurality of types of connection propriety lists only needs to be provided.

FIG. 4 is a diagram showing an example of the connection propriety lists 140b-1, 140b-2, and 140b-3. The connection propriety lists 140b-1, 140b-2, and 140b-3 stores the proprieties of connections of the wireless LAN clients 10a, 10b, and 10c with the LANs 16a, 16b, and 16c for the respective MAC addresses of the wireless LAN clients 10a, 10b, and 10c.

FIG. 4A shows the connection propriety list 140b-1 for the LAN 16a, specifically the group of the development department. The connection with the wireless LAN client (wireless LAN client 10a) having a MAC address of 00:1A:EB:00:00:01 is allowed. The connection with a wireless LAN client (wireless LAN client other than the wireless LAN clients 10a, 10b, and 10c) having a MAC address of 00:1A:EB:00:13:88 is rejected. Note that the connection of a wireless LAN client, who has a MAC address other than these, with respect to the LAN 16a is rejected.

FIG. 4B shows the connection propriety list 140b-2 for the LAN 16b, specifically the group of the sales department. The connection to the wireless LAN client (wireless LAN client 10b) with a MAC address of 00:1A:EB:00:00:02 is allowed. The connection to a wireless LAN client (wireless LAN client other than the wireless LAN clients 10a, 10b, and 10c) with a MAC address of 00:1A:EB:00:13:88 is rejected. Note that the connection of a wireless LAN client, who has a MAC address other than these, with respect to the LAN 16b is rejected.

FIG. 4C shows the connection propriety list 140b-3 for the LAN 16c, specifically the group of the general affairs department. The connection to the wireless LAN client (wireless LAN client 10b) with a MAC address of 00:1A:EB:00:00:02 is rejected. The connection to a wireless LAN client (wireless LAN client other than the wireless LAN clients 10a, 10b, and 10c) with a MAC address of 00:1A:EB:00:13:88 is allowed. Note that the connection of a wireless LAN client, who has a MAC address other than these, with respect to the LAN 16b is rejected.

The group-name storage unit (use-list storage unit) 140a stores which one of the connection propriety lists 140b-1, 140b-2, and 140b-3 (see FIG. 4) is to be used for each of the MAC addresses of the wireless LAN clients 10a, 10b, and 10c.

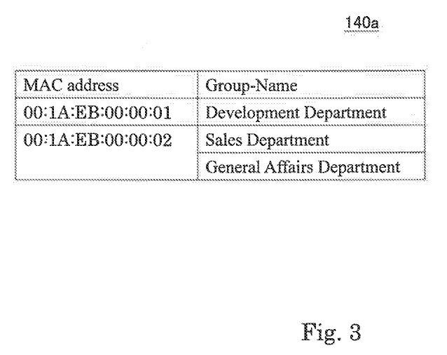

FIG. 3 is a diagram showing an example of the contents stored in the group-name storage unit (use-list storage unit) 140a. Referring to FIG. 3, the wireless LAN client (wireless LAN client 10a) with the MAC address of 00:1A:EB:00:00:01 corresponds to the group name “development department”. Thus, the connection propriety list 140b-1 (see FIG. 4A) corresponding to the group name “development department” is used. The wireless LAN client (wireless LAN client 10b) with the MAC address of 00:1A:EB:00:00:02 corresponds to the group names “sales department” and “general affairs department”. Thus, the connection propriety list 140b-2 (see FIG. 4B) and the connection propriety list 140b-3 (see FIG. 4C) which correspond to the group names “sales department” and “general affairs department” are used.

The SSID storage unit 140c stores an SSID to which one of the connection propriety lists 140b-1, 140b-2, and 140b-3 corresponds.

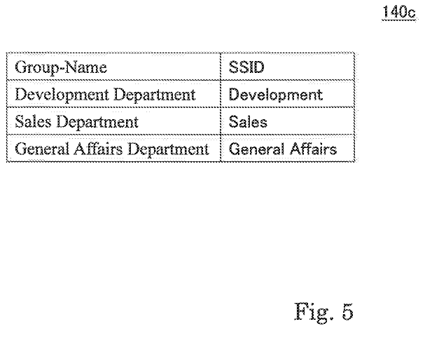

FIG. 5 is a diagram showing an example of the contents stored in the SSID storage unit 140c. The group name “development department”, specifically the connection propriety list 140b-1 corresponds to SSID “Development”. The group name “sales department”, specifically the connection propriety list 140b-2 corresponds to SSID “Sales”. The group name “general affairs department”, specifically the connection propriety list 140b-3 corresponds to SSID “General Affairs”.

Note that the LAN 16a, 16b, and 16c have the SSIDs “Development”, “Sales”, and “General Affairs”, respectively.

The group-name determination unit (use-list determination unit) 142a receives the MAC address from the wireless LAN client 10a, 10b, 10c, etc., and determines which one of the connection propriety lists 140b-1, 140b-2, and 140b-3 is to be used, based on the contents stored in the group-name storage unit (use-list storage unit) 140a (see FIG. 3).

The group-name determination unit (use-list determination unit) 142a rejects a connection request from a wireless LAN client having a MAC address not stored in the group-name storage unit (use-list storage unit) 140a. For example, the group-name determination unit 142a rejects a connection request from the wireless LAN client with the MAC address of 00:1A:EB:00:13:88.

The connection propriety determination unit 142b determines the propriety of connection of the wireless LAN client 10a, 10b, or 10c to the LAN (network) 16a, 16b, or 16c, based on the MAC address received by the group-name determination unit 142a as well as the connection propriety lists 140b-1, 140b-2, or 140b-3 determined to be used by the group-name determination unit 142a.

Note that the connection propriety determination unit 142b rejects a connection request from a wireless LAN client that has a MAC address rejected by all the connection propriety lists determined to be used. For instance, suppose the connection propriety list 140b-2 shows that the connection of the wireless LAN client having the MAC address 00:1A:EB:00:00:02 is rejected. If so, the connection of the MAC address 00:1A:EB:00:00:02 would be rejected in either the connection propriety lists 140b-2 or 140b-3 determined to be used (corresponding to group names “sales department” and “general affairs department”, see FIG. 3) (see FIGS. 4B and 4C). Thus, the connection propriety determination unit 142b would reject the connection request.

When the connection propriety determination unit 142b determines that the connection is allowable, the SSID determination unit 142c determines an SSID for use in connection with the LAN 16a, 16b, or 16c, based on the contents stored in the SSID storage unit 140c and on the corresponding connection propriety list 140b-1, 140b-2, or 140b-3, which has been used to determine the allowance of the connection. The SSID is given to the wireless LAN client 10a, 10b, or 10c and the communication unit 144.

The communication unit 144 relays the communication between the wireless LAN client 10a, 10b, or 10c, whose connection request is allowed, and the corresponding LAN 16a, 16b, or 16c.

Next, the operation of the first embodiment in the invention will be described separately depending on which one of the wireless LAN clients 10a, 10b, and 10c makes a connection request.

(A) Connection Request from the Wireless LAN Client 10a

The MAC address of the wireless LAN client 10a is 00:1A:EB:00:00:01. The group-name determination unit 142a receives the MAC address from the wireless LAN client 10a via the wireless LAN access point 12. The group-name determination unit 142a determines the use of the connection propriety list 140b-1 (see FIG. 4) that corresponds to the group name “development department” assigned to the MAC address of 00:1A:EB:00:00:01 based on the contents stored in the group-name storage unit 140a (see FIG. 3).

The connection propriety determination unit 142b determines that the connection of the wireless LAN client 10a to the LANs 16a, 16b, and 16c is allowed, based on the MAC address 00:1A:EB:00:00:01 received by the group-name determination unit 142a as well as the connection propriety list 140b-1 determined for use by the group-name determination unit 142a.

The SSID determination unit 142c determines an SSID used for connection to the LANs 16a, 16b, and 16c based on the contents stored in the SSID storage unit 140c and the connection propriety list 140b-1 (corresponding to the group name “development department”) used when determining that the connection is allowable. In this case, the SSID “Development” corresponding to the group name “development department” is determined to be used for connection to the LAN 16a, 16b, and 16c. Eventually, since the SSID “Development” corresponds to the LAN 16a, the wireless LAN client 10a can be connected only to the LAN 16a.

(B) Connection Request from the Wireless LAN Client 10b

The MAC address of the wireless LAN client 10b is 00:1A:EB:00:00:02. The group-name determination unit 142a receives the MAC address from the wireless LAN client 10a via the wireless LAN access point 12. Based on the content stored in the group-name storage unit 140a (see FIG. 3), the group-name determination unit 142a determines the use of the connection propriety lists 140b-2 and 140b-3 (see FIG. 4) that correspond to the group names “sales department” and “general affairs department” assigned to the MAC address of 00:1A:EB:00:00:02.

The connection propriety determination unit 142b determines whether the connection of the wireless LAN client 10b is allowed or not, based on the MAC address 00:1A:EB:00:00:02 received by the group-name determination unit 142a as well as the connection propriety lists 140b-2 and 140b-3 determined for use by the group-name determination unit 142a. The connection propriety list 140b-2 shows that the connection of the MAC address of 00:1A:EB:00:00:02 is allowed, while the connection propriety list 140b-3 shows that the connection of the MAC address of 00:1A:EB:00:00:02 is rejected. In this way, the connection propriety determination unit 142b determines that the connections of the wireless LAN client 10b to the LAN 16a, 16b, and 16c are allowable.

The SSID determination unit 142c determines an SSID used for connection to the LANs 16a, 16b, and 16c based on the contents stored in the SSID storage unit 140c and the connection propriety list 140b-2 (corresponding to the group name “sales department”) used when determining that the connection is allowable. In this case, the SSID “Sales” corresponding to the group name “sales department” is determined to be used for connection to the LAN 16a, 16b, and 16c. Eventually, since the SSID “Sales” corresponds to the LAN 16b, the wireless LAN client 10b can be connected only to the LAN 16b.

(C) Connection Request from the Wireless LAN Client 10c

The MAC address of the wireless LAN client 10c is 00:1A:EB:00:00:03. The group-name determination unit 142a receives the MAC address from the wireless LAN client 10a via the wireless LAN access point 12. Since the MAC address of 00:1A:EB:00:00:03 is not stored in the group-name storage unit 140a, the group-name determination unit 142a rejects a connection request from the wireless LAN client 10c.

According to the first embodiment of the invention, the authentication associated with the SSID can be performed by the MAC address authentication function. That is, the switch 14 can determine which SSID should be used to allow the connection to the LAN, specifically which LAN is allowed to be connected, in accordance with the MAC address of the wireless LAN client 10a, 10b, or 10c requesting the connection.

In the first embodiment of the invention, the authentication of the connection by the MAC address can be executed twice in total by the group-name determination unit 142a and the connection propriety determination unit 142b.

### Second Embodiment

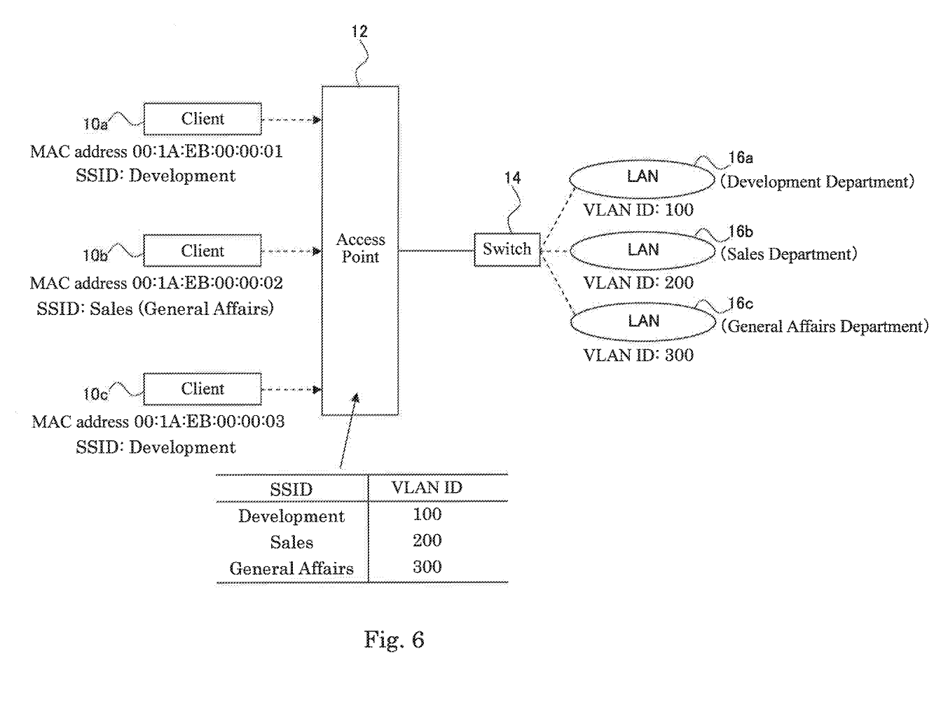

FIG. 6 is a diagram showing a wireless LAN system according to a second embodiment of the invention.

The wireless LAN system in the second embodiment of the invention includes the wireless LAN clients 10a, 10b, and 10c, the wireless LAN access point 12, the switch (connection propriety determination system) 14, and the LANs (networks) 16a, 16b, and 16c. Note that in some figures, the word “wireless LAN” is omitted and instead of this, the clients 10a, 10b, and 10c and the access point 12 are represented. The same parts as those in the first embodiment are denoted by the same reference characters as those in the first embodiment, and thus a description thereof will be omitted below.

The wireless LAN clients 10a, 10b, and 10c are the same as those in the first embodiment. Note that the wireless LAN clients 10a, 10b, and 10c are set to have SSID “Development”, “Sales” (or “General Affairs”), and “General Affairs”, respectively.

The LANs 16a, 16b, and 16c are the same as those in the first embodiment. Note that the LANs 16a, 16b, and 16c are VLAN, which are set to have VLAN ID “100”, “200”, and “300”, respectively.

The wireless LAN access point 12 is the same as that in the first embodiment. Note that the wireless LAN access point 12 performs matching (mapping) between the SSID and VLAN ID. Specifically, the SSID “Development”, “Sales”, and “General Affairs” correspond to the VLAN IDs “100”, “200”, and “300”, respectively. With this configuration, the SSIDs “Development” enables the connection only to the LAN 16a, the SSID “Sales” enables the connection only to the LAN 16b, and the SSID “General Affairs” enables the connection only to the LAN 16c.

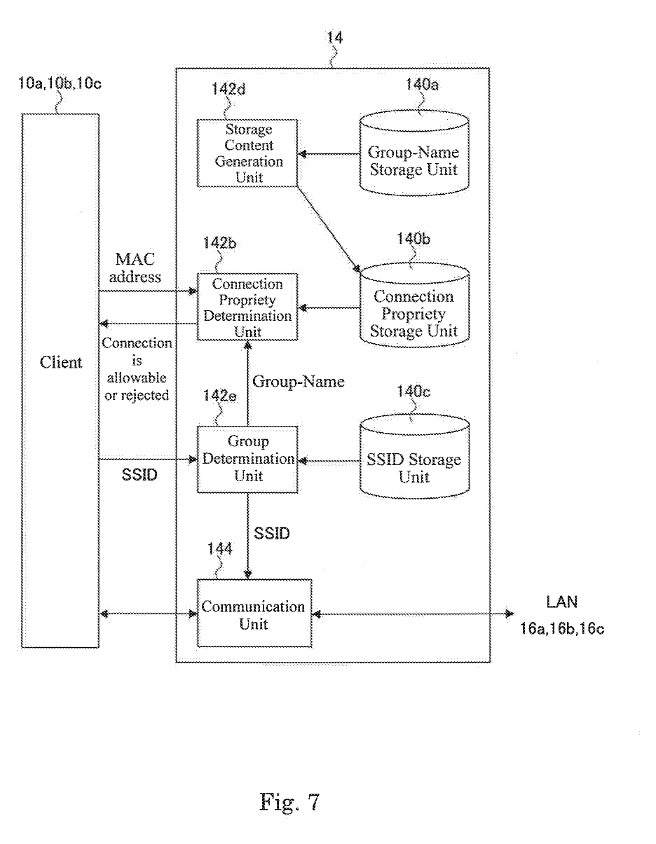

FIG. 7 is a configuration block diagram showing the configuration of the switch (connection propriety determination system) 14 in the second embodiment of the invention. Note that although in reality, the wireless LAN access point 12 is interposed between the switch 14 and the wireless LAN clients 10a, 10b, and 10c (see FIG. 1), the illustration of the access point is omitted in FIG. 7.

The switch (connection propriety determination system) 14 in the second embodiment of the invention includes the group-name storage unit 140a, the connection propriety storage unit 140b, the SSID storage unit (use-list storage unit) 140c, a storage content generation unit 142d, the connection propriety determination unit 142b, a group determination unit (use-list determination unit) 142e, and the communication unit 144.

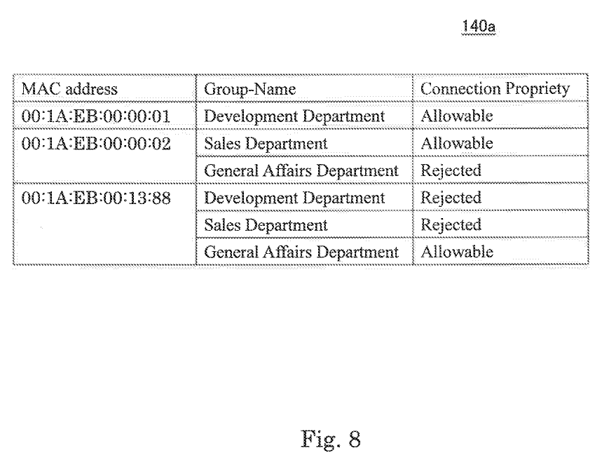

FIG. 8 is a diagram showing an example of the contents stored in the group-name storage unit 140a according to the second embodiment. The stored contents are substantially the same as an example (see FIG. 3) of the contents stored in the group-name storage unit 140a of the first embodiment. The stored contents include the MAC address of 00:1A:EB:00:13:88, as well as the propriety of the connections for the respective addresses.

The storage content generation unit 142d generates the contents (connection propriety lists 140b-1, 140b-2, and 140b-3) to be stored in the connection propriety storage unit 140b from the contents stored in the group-name storage unit 140a. Note that if the contents stored in the group-name storage unit 140a do not include any information on the propriety of connection, users are also supposed to add information on the propriety of connection to the results generated by the storage content generation unit 142d. The contents to be stored in the connection propriety storage unit 140b are preferably generated in advance before the switch 14 receives a connection request from the wireless LAN client 10a, 10b, or 10c.

The connection propriety storage unit 140b is the same as that in the first embodiment, and thus a description thereof will be omitted (see FIG. 4).

The SSID storage unit (use-list storage unit) 140c stores which one of the connection propriety lists 140b-1, 140b-2, and 140b-3 (see FIG. 4) is to be used for each SSID. The contents stored in the SSID storage unit 140c themselves are the same as those in the first embodiment (see FIG. 5). The group names “development department”, “sales department”, and “general affairs department” only need to use the connection propriety lists 140b-1, 140b-2, and 140b-3, respectively, which are the same as in the first embodiment.

The group determination unit (use-list determination unit) 142e determines which one of the connection propriety lists 140b-1, 140b-2, and 140b-3 (see FIG. 4) is to be used based on the SSID received from the wireless LAN clients 10a, 10b, 10c, and so on. For instance, referring to FIG. 5, when receiving the SSID “Development”, the connection propriety list 140b-1 corresponding to the group name “development department” is used.

The connection propriety determination unit 142b is substantially the same as that in the first embodiment. Note that the connection propriety determination unit 142b in the second embodiment receives the MAC address from the wireless LAN client 10a, 10b, 10c, and so on, and also receives the connection propriety list determined for use from the group determination unit (use-list determination unit) 142e.

The communication unit 144 relays the communication between the wireless LAN client 10a, 10b, or 10c, whose request is allowed, and the corresponding LAN 16a, 16b, or 16c. Note that the SSID is given from the group determination unit 142e to the communication unit 144.

Next, the operation of the second embodiment in the invention will be described separately depending on which one of the wireless LAN clients 10a, 10b, and 10c makes a connection request.

(A) Connection Request from the Wireless LAN Client 10a

The SSID of the wireless LAN client 10a is “Development”, and the group determination unit 142e determines the use of the connection propriety list 140b-1 that corresponds to the group name “development department”, based on the contents stored in the SSID storage unit 140c (see FIG. 5), and then sends the determination to the connection propriety determination unit 142b.

The connection propriety determination unit 142b allows or accepts a connection request from the wireless LAN client 10a based on the connection propriety list 140b-1 (see FIG. 4) and the MAC address of 00:1A:EB:00:00:01 (received from the wireless LAN client 10a via the wireless LAN access point 12).

(B) Connection Request from the Wireless LAN Client 10b

The SSID of the wireless LAN client 10b is “Sales” (or “General Affairs”), and the group determination unit 142e determines the use of the connection propriety list 140b-2 (or connection propriety list 140b-3) that corresponds to the group name “sales department” (or “general affairs department”), based on the contents stored in the SSID storage unit 140c (see FIG. 5), and then sends the determination to the connection propriety determination unit 142b.

The connection propriety determination unit 142b allows (or rejects) the connection request from the wireless LAN client 10b based on the connection propriety list 140b-2 (or 140b-3) (see FIG. 4) and the MAC address of 00:1A:EB:00:00:02 (received from the wireless LAN client 10b via the wireless LAN access point 12).

(C) Connection Request from the Wireless LAN Client 10c

The SSID of the wireless LAN client 10a is “Development”, and the group determination unit 142e determines the use of the connection propriety list 140b-1 that corresponds to the group name “development department”, based on the contents stored in the SSID storage unit 140c (see FIG. 5), and then sends the determination to the connection propriety determination unit 142b.

The connection propriety determination unit 142b rejects a connection request from the wireless LAN client 10a based on the connection propriety list 140b-1 (see FIG. 4) and the MAC address of 00:1A:EB:00:00:03 (received from the wireless LAN client 10a via the wireless LAN access point 12) (note that the connection propriety list 140b-1 does not store the MAC address 00:1A:EB:00:00:03.)

According to the second embodiment of the invention, the authentication associated with the SSID can be performed by the MAC address authentication function.

As a further alternative, the above-mentioned embodiment can be implemented as follows. A medium is prepared to store programs for implementing the above respective components, for example, the respective components of the switch 4. Then, this medium is read by a computer including a CPU, a hard disk, and a reader for media (floppy (registered trade mark) disk, a CD-ROM, etc.), so that the program is installed onto the hard disk. Even this method can implement the above-mentioned functions.

What is claimed is:

1. A connection propriety determination system that determines propriety of a request from a wireless LAN client that requests connection with a network, the connection propriety determination system comprising:
a connection propriety storage unit that stores a plurality of connection propriety lists, each of the connection propriety lists being adapted to store the propriety of connection of the wireless LAN client to the network for a MAC address of the wireless LAN client;
a use-list storage unit that stores which one of the connection propriety lists is to be used for the MAC address of the wireless LAN client;
an SSID storage unit that stores SSIDs to which the connection propriety lists correspond, respectively;
a use-list determination unit that receives the MAC address from the wireless LAN client and determines which one of the connection propriety lists is to be used, based on contents stored in the use-list storage unit;
a connection propriety determination unit that based on the received MAC address and the connection propriety list determined to be used, determines the propriety of connection of the wireless LAN client to the network; and
an SSID determination unit that, when the connection has been determined to be allowable, determines the corresponding SSID for use in connection with the network, based on the connection propriety list used to determine the allowance of the connection and contents stored in the SSID storage unit.

2. The connection propriety determination system according to claim 1, wherein:
the use-list determination unit rejects a connection request from a wireless LAN client that has a MAC address not stored in the use-list storage unit.

3. The connection propriety determination system according to claim 1, wherein:
the connection propriety determination unit rejects a connection request from the wireless LAN client having the MAC address whose connection is rejected in any one of the connection priority lists determined to be used.

4. A connection propriety determination system that determines propriety of a request from a wireless LAN client that requests connection with a network, the connection propriety determination system comprising:
a connection propriety storage unit that stores a plurality of connection propriety lists, each of the connection propriety lists being adapted to store the propriety of connection of the wireless LAN client to the network for a MAC address of the wireless LAN client;
a use-list storage unit that stores which one of the connection propriety lists is to be used for each SSID;
a use-list determination unit that determines which one of the connection propriety lists is to be used, based on the SSIDs received from the wireless LAN client; and
a connection propriety determination unit that based on the MAC address received from the wireless LAN client and the connection propriety list determined to be used, determines the propriety of connection of the wireless LAN client to the network.

5. A connection propriety determination method of determining propriety of a request from a wireless LAN client that requests connection with a network, the connection propriety determination method comprising:
storing a plurality of connection propriety lists, each of the connection propriety lists being adapted to store the propriety of connection of the wireless LAN client to the network for a MAC address of the wireless LAN client;
storing which one of the connection propriety lists is to be used for the MAC address of the wireless LAN client;
storing SSIDs to which the connection propriety lists correspond, respectively;
receiving the MAC address from the wireless LAN client and determining which one of the connection propriety lists is to be used, based on contents stored in the storing of which one of the connection propriety lists is to be used for the MAC address;
determining the propriety of connection of the wireless LAN client to the network, based on the received MAC address and the connection propriety list determined to be used; and
determining the corresponding SSID for use in connection with the network, when the connection has been determined to be allowable, based on the connection propriety list used to determine the allowance of the connection and contents stored in the storing of the SSIDs.

6. A program of instructions for execution by a computer to perform a connection propriety determination process of determining propriety of a request from a wireless LAN client that requests connection with a network, the connection propriety determination process comprising:
storing a plurality of connection propriety lists, each of the connection propriety lists being adapted to store the propriety of connection of the wireless LAN client to the network for a MAC address of the wireless LAN client;
storing which one of the connection propriety lists is to be used for the MAC address of the wireless LAN client;
storing SSIDs to which the connection propriety lists correspond, respectively;
receiving the MAC address from the wireless LAN client and determining which one of the connection propriety lists is to be used, based on contents stored in the storing of which one of the connection propriety lists is to be used for the MAC address;
determining the propriety of connection of the wireless LAN client to the network, based on the received MAC address and the connection propriety list determined to be used; and
determining the corresponding SSID for use in connection with the network, when the connection has been determined to be allowable, based on the connection propriety list used to determine the allowance of the connection and contents stored in the storing of the SSIDs.

7. A non-transitory computer-readable medium having a program of instructions for execution by a computer to perform a connection propriety determination process of determining propriety of a request from a wireless LAN client that requests connection with a network, the connection propriety determination process comprising:
storing a plurality of connection propriety lists, each of the connection propriety lists being adapted to store the propriety of connection of the wireless LAN client to the network for a MAC address of the wireless LAN client;
storing which one of the connection propriety lists is to be used for the MAC address of the wireless LAN client;
storing SSIDs to which the connection propriety lists correspond, respectively;
receiving the MAC address from the wireless LAN client and determining which one of the connection propriety lists is to be used, based on contents stored in the storing of which one of the connection propriety lists is to be used for the MAC address;
determining the propriety of connection of the wireless LAN client to the network, based on the received MAC address and the connection propriety list determined to be used; and
determining the corresponding SSID for use in connection with the network, when the connection has been determined to be allowable, based on the connection propriety list used to determine the allowance of the connection and contents stored in the storing of the SSIDs.

8. A connection propriety determination method of determining propriety of a request from a wireless LAN client that requests connection with a network, the connection propriety determination method comprising:
storing a plurality of connection propriety lists, each of the connection propriety lists being adapted to store the propriety of connection of the wireless LAN client to the network for a MAC address of the wireless LAN client;
storing which one of the connection propriety lists is to be used for each SSID;
determining which one of the connection propriety lists is to be used, based on the SSIDs received from the wireless LAN client; and
determining the propriety of connection of the wireless LAN client to the network, based on the MAC address received from the wireless LAN client and the connection propriety list determined to be used.

9. A program of instructions for execution by a computer to perform a connection propriety determination process of determining propriety of a request from a wireless LAN client that requests connection with a network, the connection propriety determination process comprising:
storing a plurality of connection propriety lists, each of the connection propriety lists being adapted to store the propriety of connection of the wireless LAN client to the network for a MAC address of the wireless LAN client;
storing which one of the connection propriety lists is to be used for each SSID;
determining which one of the connection propriety lists is to be used, based on the SSIDs received from the wireless LAN client; and
determining the propriety of connection of the wireless LAN client to the network, based on the MAC address received from the wireless LAN client and the connection propriety list determined to be used.

10. A non-transitory computer-readable medium having a program of instructions for execution by a computer to perform a connection propriety determination process of determining propriety of a request from a wireless LAN client that requests connection with a network, the connection propriety determination process comprising:
storing a plurality of connection propriety lists, each of the connection propriety lists being adapted to store the propriety of connection of the wireless LAN client to the network for a MAC address of the wireless LAN client;
storing which one of the connection propriety lists is to be used for each SSID;
determining which one of the connection propriety lists is to be used, based on the SSIDs received from the wireless LAN client; and
determining the propriety of connection of the wireless LAN client to the network, based on the MAC address received from the wireless LAN client and the connection propriety list determined to be used.
